(19) United States
(12) Patent Application Publication
(10) Pub. No.: US 2021/0213399 A1
(43) Pub. Date: Jul. 15, 2021

(54) CAVITATION PROCESS FOR WATER-IN-FUEL EMULSIONS

(71) Applicant: NANOSPECTRAL LDA, Lisboa (PT)

(72) Inventor: Carlos Alberto MARQUES FERREIRA, Sintra Montelavar (PT)

(21) Appl. No.: 15/734,273

(22) PCT Filed: Jul. 4, 2019
(86) PCT No.: PCT/EP2019/067996

§ 371 Date: Dec. 2, 2020

(30) Foreign Application Priority Data
Jul. 4, 2018 (PT) 110818

(51) Int. Cl. B01F 3/08; C10L 1/12; B01F 11/02; B01F 5/06; F23K 5/12

(52) U.S. Cl. CPC B01F 3/0819; C10L 1/125; B01F 11/0208; B01F 5/0611; B01F 5/0652; B01F 2215/0057; C10L 2200/0295; C10L 2250/084; C10L 2290/24; B01F 2003/0842; B01F 2005/0636; F23K 5/12

(57) ABSTRACT

A cavitation process for preparing a water-in-oil emulsion including a) adding water to fuel in a range of 5% to 35% of the total volume; b) feeding both water and fuel into an enclosed space, where the mixture is accelerated through a pressure rise induced by a pumping system; c) forcing the mixture through an acceleration tunnel where it hits a first cavitation barrier with adjustable bolts; d) feeding the mixture through a first decompression chamber causing a pressure decrease and subsequent vaporization of the mixture to form a vaporized mixture, forming water droplets whose diameter ranges from 1 μm to 3 μm; e) feeding the vaporized mixture on the second cavitation barrier with adjustable bolts, to a second decompression and forming water droplets of diameter of 0.1 μm or less.

### TECHNICAL FIELD

This disclosure is about a cavitation process meant to mix water with liquid hydrocarbon fuels obtained from distilled petroleum (e.g. petrol for automobile combustion engines, marine gasoil, diesel, aviation gasoline, heavy fuel oil, heating oil and waste oils), biofuels and animal or vegetable oils, by using a cavitation reactor.

### BACKGROUND

Cavitation consists of a well-known phenomenon which is achievable through Bernoulli's theorem. It occurs when a fluid flows through a physical space where pressure is decreased to vapor pressure, and the fluid boils, forming vapor pockets of liquid mass. Vapor bubbles are dragged by the fluid to the stage where they reach a higher pressure and collapse almost instantly.

Usually, cavitation is unwanted on equipment that make fluids go through, such as water and oil pumps, valves, water turbines, vessel propellers, engine pistons, and concrete overflow channels subject to high-speed flow, as the ones found in water dams, because the implosion of the vapor bubbles causes erosion on these equipment.

The virtue of the current disclosure—dispersive passive hydrodynamic cavitation, applied to the production of water-in-fuel emulsions lies on the use of the phenomenon of cavitation in a controlled way within a reactor specifically invented to perform the process, enabling the stability of vapor bubbles inside the hydrocarbon which is being emulsified with water.

Simultaneously, the hydrocarbon is subject to the same phenomenon, forming a stable emulsion since the water bubbles cannot overcome the cohesive forces, thus creating in the hydrocarbon bubbles a fusion-resistant membrane.

When light hydrocarbons are emulsified, specific surfactants should be added to the emulsion in order to strengthen the hydrocarbon resistance.

Hydrodynamic cavitation can be defined as the process of vaporization, bubble formation and implosion which occurs within a liquid flow as a result of a hydraulic section decrease and subsequent of the local pressure decrease inside the section of this specific reactor.

Cavitation only occurs if the local pressure decreases to a level below the liquid vapor pressure level and subsequent increases to a level above that one.

In a pipe system, cavitation typically occurs as a result of a kinetic energy rise (through a constriction) or a sudden pressure increase.

Thus, hydrodynamic cavitation can be obtained by making a fluid flow through a constriction at a specific speed. By going through the restriction, the combination of pressure and kinetic energy generates a hydrodynamic cavitation downstream from that constriction, which in turn produces high energy cavitation bubbles.

The process of cavitation bubbles formation and subsequent expansion and collapse results in the increase of super high energy density, local temperature, and pressure on bubbles surface during a tiny fraction of time.

Controlled cavitation can be used to improve chemical reactions or spread some types of emulsion since free radicals are formed in the process, due to the separation of vapors retained on bubble implosion.

At the beginning of the twentieth century, it became known that adding water to fuel can reduce the amount of undesirable components produced and emitted by fuel combustion. Ever since, manifold water-in-fuel emulsion techniques have been designed and tested.

However, the use of such emulsion techniques hasn't been getting a broad acceptance, namely due to their high cost, the fact that they require significant changes in the combustion engines, their poor water dispersion in the fuel, and the fact that they cannot produce stable water-in-fuel emulsions. All these factors do not only jeopardize the desirable result of emissions reduction but can cause damaging effects on combustion engines. Indeed, water-in-fuel emulsions are inherently physically unstable, meaning that they tend to separate into two layers, the water accumulating at the bottom. When that phenomenon occurs, for instance, in a fuel tank, the fuel can lower the engine performance or even cause irreparable damage.

At the present time, the most well-known emulsion techniques are: a) the ultrasonic cavitation; b) cavitation in Venturi tube; and c) agitation technique (scrubber). From those, the most effective and used water-in-fuel emulsion technique is the ultrasonic cavitation.

Nonetheless, the obtained dispersion can produce water droplets which range from 10 μm to 3 μm of diameter only. This result handicaps the water-in-fuel emulsions stability. Fuel stability is understood as the period during which a water-in-fuel emulsion remains homogeneous. In fact, the bigger diameter the water droplets have, the stronger force of attraction there is among water droplets and the subsequent water regrouping. This hinders the water-in-fuel emulsions from being held in storage for longer periods, and because the percentage of added water cannot be increased, it reduces the stored water-in-fuel emulsion efficiency.

In fact, the ultrasonic cavitation technique has a very restricted limit of water addition. The only way to overcome that restriction, ensuring that the obtained water-in-fuel emulsion maintains the same desired features, is to increase the ultrasonic vibration, which can have harmful effects on both humans and the surrounding structures.

When the ultrasound crosses the material, it is absorbed and can rise the local temperature. The ultrasound absorption rate increases according to its frequency. However, the biological changes, caused by the use of ultrasound can be the same if the absorption rate increase is induced by other agent.

Another possible effect of ultrasonic cavitation is linked with cavitation (as previously mentioned, the term used to describe the formation of cavities or bubbles within a fluid, containing variable amount of gas or vapor). In the case of biological cells or macromolecules in water suspension, the ultrasound can change them structurally and/or functionally, which may be undesirable.

The negative pressure induced on the material during rarefaction can make the dissolved or captured gases join, thus forming bubbles.

Another biological effect resulting from the ultrasonic cavitation is the one caused by the so-called “radiation forces”. They can shift, distort and/or reorient intercellular particles, or even cells, in relation to their normal configuration.

Multiple known hydrodynamic flow devices (see patents U.S. Pat. Nos. 6,705,396, 7,787,712, 6,502,979, 5,971,601, and patent application WO2009/004604) describe different hydrodynamic cavitation reactors and their use.

The American patent U.S. Pat. No. 7,338,551 discloses a device and a method to create bubbles in a fluid that flows through a first constriction zone of that hydrodynamic cavitation device, which is then mixed with gas to increase the implosion within the second constriction zone. Even though the alluded device has been designed with two cavitation zones, its efficiency is not satisfactory whenever a larger amount of successive cavitation operations are required.

The patent application WO2009/004604 discloses the use of a vibro-acoustic process to produce emulsions. The diameters of water droplets generated by this process range between 10 μm and 3 μm, explaining why such as vibro-acoustic process is not satisfactory to produce water-in-fuel emulsions.

The U.S. Pat. No. 6,042,089 discloses the use of the Venturi effect to produce foam with air bubbles presenting a diameter as big as 20 micrometer. As the diameter of the generated bubbles is generally bigger than 10 μm, the cavitation process disclosed in U.S. Pat. No. 6,042,089 cannot be transposed to the production of water-in-fuel emulsions.

The patent application WO 2014/134115 disclosed an emulsifying process using cavitation to produce water droplets. A control device is arranged at the entry of a cavitation chamber to modify the velocity of an incoming fluid flow and thus allow for a better tuning of the diameter of the obtained droplets. However, obtained droplets are never smaller than 1 micrometer and the device must be used directly at the point where the emulsion is needed, as the produced emulsion present no long term stability.

Another approach is given by the American patent U.S. Pat. No. 5,969,207, which uses a flow pipe with a deflector capable of generating hydrodynamic cavitation. Through its cavitation operation, this patented device can induce chemical changes meant to modify qualitatively and quantitatively the composition of liquid hydrocarbons.

The Russian patent 2143312, B 01 J 10/00 discloses a gas-liquid produced by a vortex cavitation device which is encircled by a cylindrical vertical enclosure. The alluded cavitation device is located in the intermediary section of that enclosure, and it is equipped with mixing chambers and foam chambers attached by a constricting nozzle. The feeding tube, which is aligned coaxially with the mixing chamber, operates as a cavitation nozzle with a conic separator. In order to produce a whirlpool flow, the feeding tube has eight square threads whose pitch is 2 to 5 mm long. A complex manufacture and a high flow resistance, due to the whirlpool effect, are the main handicaps of this device.

The Russian patent 2126117, F 24 J 3/00 unveils a heating cavitation device designed with a cylindrical enclosure, a Venturi nozzle and a deflector body which is located in its inner part. A rotating impeller is positioned inside the Venturi nozzle, in front of the deflector body. The outer surface of the deflector body has longitudinal grooves which are sensitive to the impeller and are attached to the other end of the deflector body. The main handicap of the alluded device is the financial manufacturing cost. Furthermore, the impeller is subject to interferences, thus reducing the treatment efficiency

On the other hand, the Russian patent 2158627, B 01 J 5/08 publishes the disclosure of a cavitation mixer consisting of a cylindrical working chamber, a fluid feeding nozzle with a convergent cone shape, and a cone-shaped beak to discharge the atomized fluid. The chamber flow inlet has one nozzle to mix fluids which is followed by a nozzle designed to an optional inlet to make possible the inflow of optional components. The working chamber has a circular channel connected to its inner part. The inner surface of the chamber's rear end is characterized by radial longitudinal grooves. This device is not capable of creating a uniform cavitation field inside the working chamber, and as a result the process efficiency is poor.

A high-efficient flow hydra-sonic device is described by the American patent U.S. Pat. No. 5,188,090 as a cylindrical rotor equipped with several peripheral cavities. That rotor spins within an enclosure supported by a shaft, which in turn is supported by ball bearings, and enclosed by mechanical seals. An engine is required to activate the rotor. The manufacture of this device is complex and expensive. Also, the vibration generated by the shock waves, and the rotor's uneven erosion induced by cavitation are the main causes of premature malfunction of the rotor, the ball bearings, and the mechanical seals.

The American patents U.S. Pat. Nos. 5,957,122, 6,595,759, 6,910,448, 6,976,486 and 7,089,886 regard invented cavitation devices consisting of rotors equipped with cavities.

Still with regard to the disclosure of cavitation devices that comprise rotors designed with cavities or orifices, the American patent U.S. Pat. No. 7,767,159 describes a rotor which interacts with a stator, both designed with peripheral holes. When those holes match, they enable the flow of the fluid pressurized by the centrifugal force, based on a frequency given by the product of number of holes multiplied by the number of rotations, generating high pressure pulses upstream from the flow, and low pressure pulses downstream from the flow. In fact, those pulses form a small water hammer effect. The alluded cavitation device has the same kind of problem as the one disclosed by the U.S. Pat. No. 5,188,090.

The aim of the present disclosure is to prevent the above mentioned shortcomings from happening.

### BRIEF DESCRIPTION OF THE DRAWINGS

FIG. 1—shows the system working diagram, where (10) corresponds to a fuel tank, (11) a water tank, (12) an electric resistance, (13) a solenoid valve, (14) a level gauge transmitter, (15) (16) connections to production, (17) an inflow pressure transmitter, (18) an outflow pressure transmitter, (19) a fuel isolation valve, (20) a water isolation valve, (21) a fuel pump, (22) a water pump, (23) a fuel check valve, (24) a water check valve, (25) a fuel Coriolis flow meter, (26) a water ultrasonic flow meter, (27) a secondary passage valve, (28) a pressure gauge transmitter, (29) a reactor, (30) water-in-fuel emulsion outlet to the production, (31) the production, (32) a PLC—Power Line Communication.

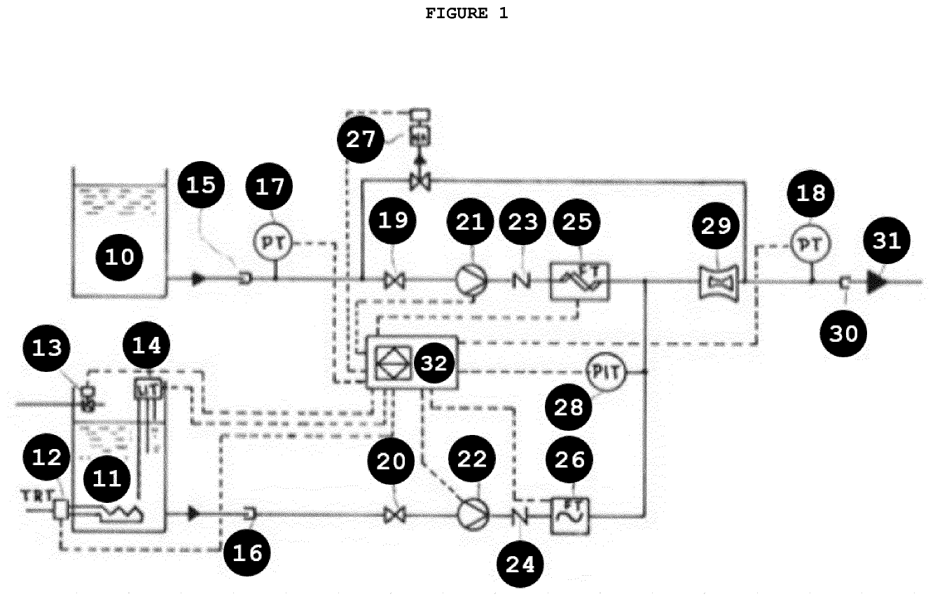

FIG. 2.1—shows a side section of the reactor (29), where (1) corresponds to the reactor body, (33) the cavitation bolts, (2) the mixture inlet, (3) the acceleration tunnel, (4) (5) the expansion chambers, (6) the barriers with adjustable bolts, and (33) (7) the fixing flanges of the reactor (29).

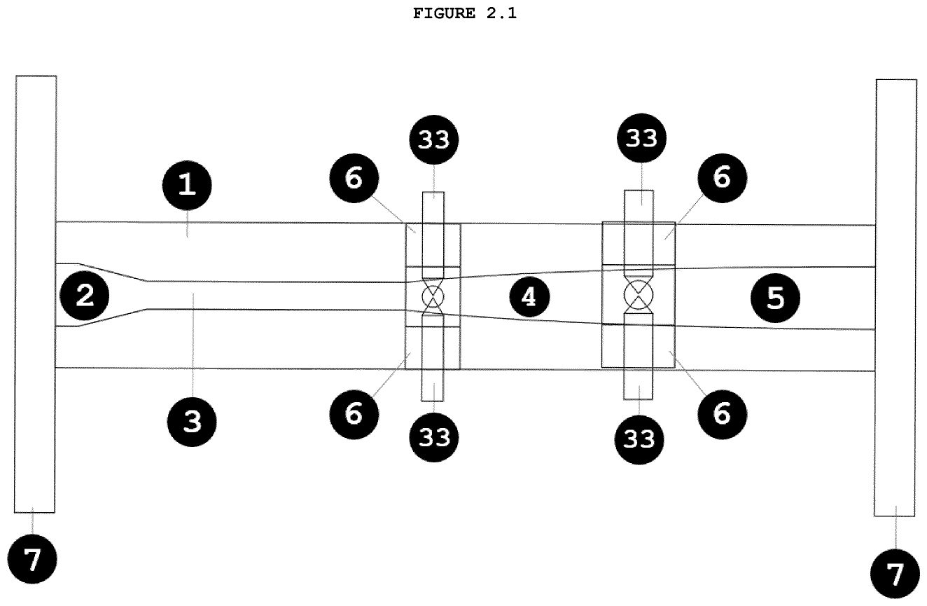

FIG. 2.2—shows a frontal section of the reactor (29) on one of the barriers (6) where are fixed the cavitation bolts (33), where (1) corresponds to the reactor body.

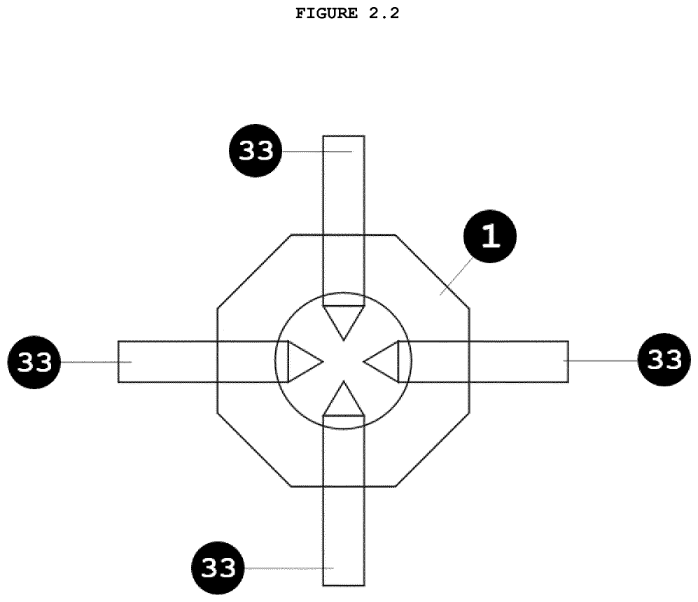

FIG. 2.3—shows one of the cavitation bolts (33) of the reactor (29), where (8) corresponds to a sealing nut, and (9) a fixing nut.

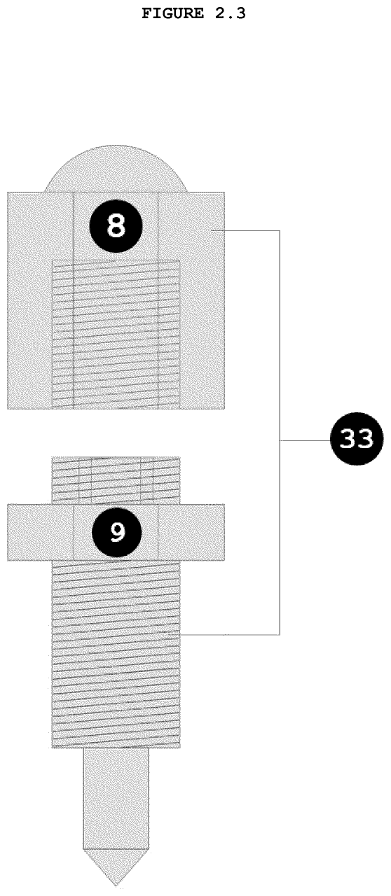

### DETAILED DESCRIPTION

The present cavitation process is meant to produce water-in-fuel emulsions, by using a hydrodynamic cavitation reactor (29), which has been specifically designed for the purpose. The reactor (29) is a key element of the proposed cavitation system.

The reactor (29) comprises a flanged prismatic body (1) with a polygonal section i.e. it can be triangular, quadrangular, hexagonal or octogonal in steel, tungsten or titanium. In the reactor an acceleration tunnel (3) has been constructed preferably drilled. The acceleration tunnel (3) comprises three distinct zones: the mixture entry (2); the acceleration tunnel (3), and the decompression or expansion chambers (4) (5). The second expansion chamber (5) is also the mixture outlet. Two cavitation barriers with adjustable bolts (33) are placed in the acceleration tunnel (3) in order to separate the two decompression chambers (4) (5). The quantity and size of the adjustable bolts (33) may be adapted, according to the fuel type to be emulsified with water, and the kind of metal the reactor (29) is made of. The adjustable bolts (33) are preferably built in the same metal as the reactor, e.g. steel, tungsten or titanium.

The bolts (33) are adjusted from the dispersive passive hydrodynamic cavitation reactor's (6) outer part. On the one hand, the fixing nut (9) enables to fasten the plug (6) to the reactor body (1), and, on the other hand, the sealing nut (8) is meant to tighten the plug (6), so that possible fuel leaks from the plug thread gauge can be prevented, taking into account that the pressure generated by the cavitation process is substantially high.

According to the fuel type to be emulsified with water, any adjustments on the bolts (33) can be made without interrupting the cavitation process.

Thus, on this water-in-fuel cavitation process, the mixture of fuel with water is accelerated by the pressure increase, caused by a pumping system (21) (22), which preferably operates on a range of 15 to 25 bar, and is forced to go through the acceleration tunnel (3) of the reactor (29), where it hits the first cavitation barrier with adjustable bolts (33). By expanding in the first decompression chamber (4), the mixture undergoes a pressure decrease and subsequent vaporization, releasing water droplets whose diameter ranges from 1 μm to 3 μm. Thereafter, the vaporized mixture hits the second cavitation barrier with adjustable bolts (33), where it undergoes a new decompression (5). The second vaporization of the mixture spawns a new micronization, since the acceleration tunnel (3) widens, causing a pressure decrease to 6 bar. This double vaporization process obtained from the architecture of the flow modelling system operated by a suitable combination of the number of adjustable bolts (33), the reactor (29), their size and distance range enable water droplet micronization, whereby the droplet diameter can range between 0.1 μm and 1 μm. This enables to emulsify fuel with water in such a way that the water percentage of the emulsion total volume can go even higher than 35%.

The results achieved by the present disclosure exceed by far those obtained through the existing processes available on the market. By producing a water-in-oil emulsion whose total volume contains around 35% of water, this process is capable of bringing about a reduction in fuel consumption 35%. Existing processes generate results that don't exceed 20% of fuel saving.

In terms of exhaust gas emissions, the emulsion is responsible for the following results:

a) NOX (nitrogen oxide)=−65%
b) NO (nitrogen monoxide)=−70%
c) CO2 (carbon dioxide)=−75%
d) CO (carbon monoxide)=−100%
e) SO2 (sulphur dioxide)=−100%
f) O2 (oxygen)=+30%

### g) XAIR=+350%

The current process enables the creation of water nanoparticles homogeneously dispersed, encapsulated inside a drop of fuel. When the fuel nano-emulsion is sprayed into a superheated engine combustion chamber, the water part of the water-in-oil emulsion expands, and a micro-explosion takes place due to a sudden temperature rise. This reaction creates the fuel separation around the water that falls in the form of minuscule particles. These minuscule water particles will then expand and explode. As a result, the combustible air-fuel surface increases significantly which leads to a more efficient fuel combustion.

In fact, the oxidized particles are much smaller, and as the vapor superheats them, the reaction occurs instantly and smoothly.

Consequently, the fuel combustion is more effective when comparing the present disclosure with the processes whereby the water particles are released in their conventional size.

The described phenomenon, as previously mentioned, enables to achieve a much higher fuel saving, as well as a significant reduction of harmful exhaust gases emitted into the atmosphere, caused by fuel combustion, without compromising the engine performance, whether it is a combustion engine, a generator, a boiler, a burning furnace, or any other equipment that can use a water-in-oil emulsion. Moreover, the water-in-oil emulsions obtained through the current process are unquestionably more stable, because the water droplets have a uniform diameter distribution (diameter=0.1 μm to 1 μm), which enables the emulsion to be stored and remain stable and unchanged for a period of time longer than two years.

To sum up, this process and the resulting emulsion has the following advantages:
1. Reduction of polluting gas emissions;
2. Decrease of the fuel consumption;
3. More efficient and reliable combustion engine cleaning, as the produced water-in-oil emulsion has less particles;
4. Greater quality and more effective fuel combustion;
5. Applicability to two-cycle low speed engines, and four-cycle medium and high speed engines;
6. Applicability to existing and future designed ships engines, and fossil fuel burning power plants;
7. Capability of processing water-in-oil emulsions with heavy fuel oils and light fuel oils; and
8. Greater stability of the produced water-in-oil emulsions wherein the water part doesn't separate from the fuel over a long period of time (more than two years).

As it is detailed below, the proposed process and reactor (29) can be used in different ways. One of them is to apply the process to the emulsion production of several batches of fuel to be stored in a storage tank, and then transferred to the feeding tank.

As the engine starts, it is connected to the fuel feeding tank (10), and the connection to the emulsion tank (31) is performed. The isolation valves are opened (19) (20). It is noted that there is no fuel spill into the water tank (11), because the valve (16) prevents such a spill. The command is entered in the PLC (Power Line Communication) (32) for the boot sequence to begin. The fuel pump (21) starts, and after a few seconds, the water pump (22) starts as well. The starting routine checks the regular engine performance and initiates the by-pass valve (27) closing. The PLC (32) regulates the fuel pump (21) to the desired flow of the reactor (29), forcing the desired water percentage to be added to the water-in-oil emulsion to the water pump (22). Any variation of the suction pressure is offset by the increase or decrease of the rotation in both pumps (21) (22).

Through the PLC (32) dashboard the following parameters can be permanently (locally or remotely) monitored:

1. Instant fuel flow;
2. Fuel capacity totalizer (in liter);
3. Instant water flow;
4. Water capacity totalizer (in liter);
5. Fuel/water percentage;
6. Inner tank temperature setting;
7. Water temperature;
8. Water tank minimum level warning;
9. Water tank below minimum level warning.

By monitoring one or more of these parameters, the operator can readily and effectively manage the production of the desired batches of water-in-oil emulsions as well as the available storage tanks.

Another possible use of the proposed process is the in-line operation upstream and downstream of the preparation water-in-oil emulsion facility whose tanks are connected to the combustion engine feeding tank.

In this embodiment, the equipment is connected to the fuel line in (15) and (30), and the by-pass valve (27) is open. The fuel valves (19) and the water valves (20) are also open. The equipment is on stand-by mode, and the engine feeding fuel is passing directly through the valve (27). When the “start” command is entered in the PLC (32), the boot sequence initiates, as it is described on the previous operation mode.

The fuel pump (21) starts, adjusting its operation in accordance with the line pressure input by the pressure transmitter (17). Thereby, the cavitation is initiated. Downstream, the pressure transmitter (18) checks the load loss imposed by the cavitation reactor (29), and increases the fuel pump (21) rotations, based upon the required pressure on the outlet (18). During this period, the water pump (22) starts, and injects gradually the required water percentage until it reaches the programmed value to produce the water-in-oil emulsion.

Regardless of the operation mode applied to the engine, the pressure balance and the water/fuel mix are held simultaneously.

In case the engine stops, the cavitation system stops as well. The by-pass valve (27) opens, being the equipment in stand-by mode for a new boot sequence.

As a last note, the reactor (29) can be used to process dry fuel, i.e. without adding water to it. In such operation mode, the achieved result consists in an improved fuel combustion thanks to the cracking effect caused by the reactor (29), as it is capable of breaking hydrocarbon long molecules into less complex ones, which boosts the improvement of hydrocarbon burning and reduces the hydrocarbon combustion residues.

Embodiment 1 A cavitation process for preparing a water-in-oil emulsion, characterized by the steps of:
a) adding water to fuel in a range of 5% to 35% of the total volume;
b) feeding both water and fuel into an enclosed space, wherein the mixture is accelerated through a pressure rise induced by a pumping system (21) (22);
c) forcing the mixture through an acceleration tunnel (3) wherein it hits a first cavitation barrier with adjustable bolts (33);
d) feeding the mixture through a first decompression chamber (4) causing a pressure decrease and subsequent vaporization of the mixture to form a vaporized mixture, forming water droplets whose diameter ranges from 1 μm to 3 μm;
e) feeding the vaporized mixture on the second cavitation barrier with adjustable bolts (33), to a second decompression and adjusting the number and arrangement of adjustable bolts in order to control the formation of water droplets of diameter of 0.1 μm or less.

Embodiment 2—Cavitation reactor (29) for use in the process of Embodiment 1, the reactor (29) comprising a flanged prismatic body (1) with a polygonal section with an acceleration tunnel (3), comprising three distinct zones: a mixture entry (2); an acceleration tunnel (3), and a first and second decompression or expansion chamber (4) (5) wherein the second expansion chamber (5) is also the mixture outlet.

Embodiment 3—The cavitation reactor according to Embodiment 2, wherein the polygonal section of the reactor is triangular, quadrangular, hexagonal or octagonal.

Embodiment 4—The cavitation reactor according to any of the embodiments 2 or 3, wherein the reactor is made of steel, tungsten or titanium.

Embodiment 5—The cavitation reactor according to any of the Embodiments 2 to 4, wherein the two cavitation barriers with adjustable bolts (33) are placed in the acceleration tunnel (3) in order to separate the two decompression chambers (4) (5).

Embodiment 6—The cavitation reactor according to any of the Embodiments 2 to 4, wherein the adjustable bolts (33) are adjustable from the reactor's (6) outer part.

Embodiment 7—The cavitation reactor according to Embodiment 6, said bolts (33) comprising a fixing nut (9) to fasten the plug to the reactor body (1), and a sealing nut (8) to tighten the plug (6).

Embodiment 8—A Water-in-oil emulsion obtainable by the process of Embodiment 1, wherein the water/fuel ratio between 5% to 35% of the total volume, the water droplets have a uniform distribution of a diameter between 0.1 μm to 1 μm.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “some embodiments,” “an embodiment,” and so forth, means that a particular element described in connection with the embodiment is included in at least one embodiment described herein, and may or may not be present in other embodiments. In addition, it is to be understood that the described elements can be combined in any suitable manner in the various embodiments.

Unless defined otherwise, technical and scientific terms used herein have the same meaning as is commonly understood by one of skill in the art to which this application belongs.

1. A cavitation process for preparing a water-in-oil emulsion, comprising:
a) adding water to fuel in a range of 5% to 35% of the total volume;
b) feeding both water and fuel into an enclosed space, wherein the mixture is accelerated through a pressure rise induced by a pumping system;
c) forcing the mixture through an acceleration tunnel wherein it hits a first cavitation barrier with adjustable bolts;
d) feeding the mixture through a first decompression chamber causing a pressure decrease and subsequent vaporization of the mixture to form a vaporized mixture, forming water droplets whose diameter ranges from 1 μm to 3 μm;
e) feeding the vaporized mixture on the second cavitation barrier with adjustable bolts, to a second decompression and adjusting the number and arrangement of adjustable bolts in order to control the formation of water droplets with a diameter between 0.1 μm and 1 μm.

2. A cavitation reactor for use in the process of claim 1, the reactor comprising a flanged prismatic body with a polygonal section with an acceleration tunnel comprising three distinct zones: a mixture entry; an acceleration tunnel, and a first and second decompression or expansion chamber wherein the second expansion chamber is also the mixture outlet.

3. The cavitation reactor according to claim 2, wherein the polygonal section of the reactor is triangular, quadrangular, hexagonal or octagonal.

4. The cavitation reactor according to claim 2, wherein the reactor is made of steel, tungsten or titanium.

5. The cavitation reactor according to claim 2, wherein the two cavitation barriers with adjustable bolts are placed in the acceleration tunnel in order to separate the two decompression chambers.

6. The cavitation reactor according to claim 2, wherein the adjustable bolts are adjustable from the reactor's outer part.

7. The cavitation reactor according to claim 6, said bolts comprising a fixing nut to fasten the plug to the reactor body, and a sealing nut to tighten the plug.

8. A Water-in-oil emulsion obtainable by the process of claim 1 wherein a water/fuel ratio is between 5% to 35% of the total volume, the water droplets have an uniform distribution of a diameter between 0.1 μm to 1 μm.
